(19) United States
(12) Patent Application Publication
(10) Pub. No.: US 2013/0059044 A1
(43) Pub. Date: Mar. 7, 2013

(54) EQUIPMENT AND PROCESS FOR PREPARATION OF FOOD PRODUCTS HAVING CLOSED LOOP CONTINUOUS SHAPES

(71) Applicant: Alan THORPE, St. Eleanor's (CA)

(72) Inventor: Alan THORPE, St. Eleanor's (CA)

(73) Assignee: CAVENDISH FARMS CORPORATION, Dieppe (CA)

(21) Appl. No.: 13/226,836

(22) Filed: Sep. 7, 2011

(51) Int. Cl. B26D 7/00; A23B 7/02; A23L 1/27; A23L 1/214; A23B 7/04; A23P 1/08; A23L 1/217; B26D 1/01; A23L 1/01

(52) U.S. Cl. 426/243; 83/651; 83/835; 83/27; 426/519; 426/509; 426/473; 426/262; 426/438

(57) ABSTRACT

To cut food material, in particular potatoes and sweet potatoes, into continuous close-loop shapes, a cutting blade assembly is used. The cutting blade assembly consists of an outer and at least one inner concentrically arranged cutting blade, where each cutting blade has a close-loop cross-sectional shape. The space between adjacent cutting blades forms a cutting tube. The cutting tubes ultimately form the cross-sectional shapes of the cut food material. Supports, such as blade guides and plungers are slidably positioned between the cutting blades in the cutting tubes. These supports maintain the distance between adjacent cutting blades and assist in separating cut food material from the cutting blades. This cutting blade assembly may be used in a method and system for cutting food material into continuous close-loop shapes.

### FIELD OF THE INVENTION

The present invention is related to a cutting blade assembly and cutting system for making closed loop continuous food products cut from a food material such as potatoes, sweet potatoes or any other fruit or vegetable which is oblong in nature.

### BACKGROUND OF THE INVENTION

French fries are a basic staple for quick service and food service restaurants and are also widely prepared at home. Potato products have been cut into a large number of different shapes and sizes in an attempt to present new options to consumers and restaurants. These cuts have generally been dictated, however, by the shape of the potato itself. The most commonly used potatoes for French fry production have one thing in common and that is their shape; they are all oblong in shape, ideally being approximately 1.5 times as long as they are wide. They can, therefore, be considered to have a long (longitudinal) axis and a short (transverse) axis.

Generally, potatoes are cut in a longitudinal fashion into straight and wedge cuts, or cut longitudinally and then transversely to make diced products. French fries are typically presented, in one fashion or another, as straight line cuts from the potato tissue.

Consumers are looking for novel cuts in an attempt to have a variety in their eating experience. Food service and quick service operators (i.e. restaurants) are in an extremely competitive market and need a point of differentiation from their competition. They are also driven to control the costs they incur for their purchases of food items.

The vegetable component of a meal is typically less expensive than the protein fraction, but takes up equal space on the plate. When dealing with the vegetable component, plate coverage is extremely important to a restaurant. Ideally, the restaurant seeks to minimize the actual amount of food on the plate, while still presenting the plate to make it look like it is full. One way to do this is to use a product which does not stack well. Fries with irregular surfaces such as crinkle cut strips and thin cut strips such as julienne do not stack well, and contain a large proportion of empty space when piled on a plate. A method of increasing the plate coverage is to have more empty space between each potato unit. A closed loop shape, consisting of a thin strip enclosing a large empty space provides good plate coverage at low cost.

A large number of commercial machines are available on the market which will cut a potato into a stick like configuration which may have flat or smooth sides. These are basically two dimensional cutter systems which cannot by their inherent design make complex cuts. Of particular interest is the spiral or curly fry which makes a non-closed loop cut. This cut is essentially a straight cut fry which has been cut to make coils of potato material. This is accomplished by forcing the material to be cut through a rotating cutter blade. The cutter blade contains cutting elements which are positioned perpendicular to a rotating cutter base. A second cutting means in the rotating cutter base makes slices as the material is forced through it. Because this cut contains a large proportion of empty space, this cut has good plate coverage. This type of fry, however, is easy to break leading to quality issues. A closed configuration yields a much higher inherent strength to the cut pieces than a spiral configuration.

While plate coverage is an important factor in the decision by a restaurant in choosing a potato product to use, the cost of the product as sold to the restaurant is also a very important factor. For this reason, production costs at the manufacturing plant must be low. This means that the transformation of the potatoes into finished product must be as efficient as possible, with minimal waste. Various methods for making decorative cuts have been patented including those of Mendenhall (U.S. Pat. No. 4,911,045), Behnke (U.S. Pat. No. 2,483,173) and Valle (U.S. Pat. No. 2,119,260) are quoted in the patent literature, but these patents generate a huge amount of waste through the cutting process, and are therefore not economical options for commercially making specialty cuts of French fries.

Equipment to make slices through a vegetable or fruit, such as the Urschell™ OV slicer has been available for years. This equipment makes slices at production volumes by forcing the material lengthwise through a wheel fitted with rotating blades, or a stationary slice knife. The wheel or stationary blade may be flat or undulating, depending on whether a flat slice or crinkle cut slice is desired.

Another method of slicing that is known and utilized at home and in restaurants is the cookie cutter. The cookie cutter will cut a desired shape out of a flat sheet of dough, or out of a fruit or vegetable which has first been sliced to provide flat slabs. In order to produce shapes which are of a closed loop configuration, it is necessary to use another cookie cutter of smaller diameter and position this cutter over the first cut piece and cut a smaller plug out of the centre of the first cut piece. There are numerous problems with such a procedure. Since the centering of the secondary cutter over the first cut piece is a manual operation the process is both tedious and variable. An additional problem with this procedure is that the food material can become lodged in the cookie cutter, making it difficult to remove.

The literature contains other systems for cutting vegetables into various different shapes by different methods. Most of these methods yield simple shapes. In U.S. Pat. No. 2,836,212 (Shaw) a system is described for making slices from a potato or other vegetable piece. The equipment described for performance of this operation forces a set of cutter blades through the vegetable piece to be cut yielding a plurality of slices of potato which, when the cutter has completely passed through the vegetable, separate into slices. The process described is a manual cutter system whereby the vegetable piece is placed into the cutter and the resulting pieces are removed from the cutter in a manual process. U.S. Pat. No. 5,142,973 (Tur et al.) describes a cutter for onions wherein the onion is manually positioned into the cutter system and a set of cutting blades are forced partially through the onion. When the cutter assembly is retracted, the onion remains intact due to attachment of the cut pieces to the uncut bottom portion of the onion. U.S. Pat. No. 5,035,915 (Mendenhall) describes a method and apparatus for cutting helical split ring French fry strips. This patent relies upon first cutting the potato with a slot cutter and subsequently cutting the potatoes into a concentric helical cutter. The resulting product is a ring shaped product which does not have a closed loop configuration, but is a split ring configuration. The split rings are a much more fragile product than the cut resulting from the invention herein described, and will break on the processing line resulting in unusable units.

Of particular interest to the present invention are the following patents related to methods for cutting of food materials into complex shapes. For instance, U.S. Pat. No. 865,628 (Carsley) discloses a method of cutting vegetables into cylinders through the use of concentric cylindrical cutting blades. Carsley discloses a device comprised of a pair of concentric cylindrical cutting blades. The device described is essentially a doughnut cutter and does not address removal of the cut pieces from the cutter subsequent to penetration of the substrate by the blades.

U.S. Pat. No. 4,681,000 (Wolters) teaches a manual method for cutting a food material of a predetermined depth into specific shapes. Wolters teaches that the blades may not pierce the entire body of the material to be cut, to aid in the extraction of the blades from the material to be cut without plugging the blades. Wolters discusses the need to avoid compression of the material to be cut. To avoid such compression, Wolters suggests that the blades be 1/100 inch thick or less. Further, Wolters relies upon food pieces which have been precut to a defined shape and depth prior to being cut by the cutter described therein. If the size is not correct, either excessive waste or improper figures will be the end result. The method in Wolters also leaves behind an end plug which has not been cut into the desired shapes and which would have to be removed from the process. The equipment so described has a major flaw in that upon withdrawal from the food piece the food piece can be broken off inside the cutter, plugging the cutting elements. Wolters addresses the cutting of a single shape from a food piece with provision made for cutting small decorative shapes from the interior of said shape. This invention does not address the stress placed upon the food piece which occurs by inserting a multitude of concentrically shaped blades through the substrate. Concentric blades at small spacings of ¼ to ½ inch between concentric blades will cause the substrate to experience severe stress. Where the blades are beveled to force the tissue outwards from the centre of the potato as in Wolters, the stress will displace the tissue by the width of the blade thickness. In this configuration it is necessary to ensure that the blades are made of extremely thin metal to prevent stress cracking of the tissue. The extreme thinness of the blades described in Wolters would not withstand the rigors of a processing facility and would be suitable solely for hand cutting of product.

U.S. Pat. No. 5,662,033 (Yawman) describes a manual food cutting apparatus for producing ring-shaped foods. According to Yawman, a food article, such as a potato is placed in an aperture of a base member of the apparatus, the aperture being defined substantially longitudinally in the base member. A cutting member having a plurality of circular cutting blades arranged in concentric arrangement is telescopically inserted within the aperture over the food article, passing entirely through the food article to cut the food article substantially longitudinally. Optionally, an ejecting means having a handle and series of appropriately spaced prongs to push the ring-cut food article from the circular cutting blades. Also optionally, the base member may have a plurality of lateral slots, through which a second cutting device may be inserted to make lateral slices. It is therefore contemplated that the cut food pieces would remain together throughout the cutting process (i.e. during both lateral and longitudinal cuts). As mentioned above, the compression caused from concentric blades cutting in such close proximity causes stress on the food article being cut, and subsequently on the cutting blades themselves. Yawman does not provide support for the blades that would be needed during commercial cutting, which can result in flexing and/or altered alignment of the blades. The ejecting means in Yawman is not contemplated for use in guiding the blades or relieving the stress that results from the compression of the food article during cutting.

The existing cutting methods are deficient in being able to produce food products such as potato products having continuous loop configurations at commercial volume. Most of the cutters developed to date have been variations on a cookie cutter, and are neither robust enough to survive in a manufacturing environment, nor automated enough to provide cutting at the necessary volumes to support a commercial operation.

### SUMMARY OF THE INVENTION

A cutting blade assembly for use in cutting food material into continuous closed-loop shapes is described. A cutting means has an outer cutting blade and at least one inner cutting blade. The cutting blades are concentrically arranged and the space between adjacent cutting blades forms a cutting tube. Supports are slidably positioned in the cutting tubes to maintain the distance between adjacent cutting blades and to assist in separating cut food material from the cutting blades. Each cutting blade has a closed-loop cross-sectional shape and has a cutting surface having an inner cutting side and an outer cutting side.

Also described is a method for cutting a food material into concentric, closed loop shapes. Food material is individually positioned under the cutting blade assembly described above. The cutting blades of the cutting assembly are forced through the food material to produce concentric cuts through the food material. The cutting blades are removed from the food material such that the food material remains fully intact. The cut food material is further cut transverse the concentric cuts and the cut food material is separated into concentric shaped food pieces.

Further embodiments will be clear having further regard to the description and claims below.

### BRIEF DESCRIPTION OF THE DRAWINGS

FIG. 1a is a prospective view of a cutting assembly.

FIG. 1b is a side view of the cutting assembly of FIG. 1a.

FIG. 1c is a side cross-sectional view of a cutting means of the cutting assembly of FIG. 1a.

FIG. 1d is a cross sectional view along line B-B of FIG. 1b.

FIG. 2a is a prospective view of a support means.

FIG. 2b is a cross sectional view of the support means of FIG. 2a in combination with the cutting blades.

FIG. 3 is a perspective view of a preferred system of cutting food articles by the cutting assembly into various shapes.

FIG. 4 depicts the cut food article using the system of FIG. 3 at various stages of cutting.

### DETAILED DESCRIPTION

The present invention is related to a cutting blade assembly and cutting system for making food products having closed loop continuous cut shapes from a food material such as potatoes and sweet potatoes. While the description below focuses primarily on the application to potatoes, it is by no means intended to be limited to potatoes and can have application to other foods, particularly those having tubular or elongate shape such as carrots, turnips, beats and the like. By using the cutter system described it is possible to cut the food material into elongated cylindrical tubes which, when cut at an orientation of 90 degrees to the cylindrical cuts, will yield closed continuous forms such as rings, ovals, stars, squares and other shapes.

A cutting blade assembly 10 is used to cut food material into continuous closed-loop shapes. The cutting blade assembly 10 includes a cutting means 30 having an outer cutting blade 22 and at least one inner cutting blade 24 depending on the desired number of shapes and the size of the food article to be cut. The cutting blades 22, 24 are concentrically arranged and each cutting blade has a closed-loop cross-sectional shape.

The cutting blades typically have a circumference ranging from between about 0.5″-4″, a length ranging from between about 6″-10″, and a thickness ranging from between about 0.02″-0.05″. Preferably, the cross-sectional shapes are circles, but the cross-sectional shapes may be other shapes, such as stars, squares, ovals, or triangles. The outer cutting blade 22 and the at least one inner cutting blade 24 need not have the same cross-sectional shape.

Each cutting blade has a cutting surface 26 having an inner cutting side, generally facing towards the centre of the cutting blade, and an outer cutting side generally facing the perimeter of the cutting blade. The inner cutting side of the cutting blades may be beveled and the outer cutting side of the cutting blades may be flat. Alternatively, both the inner cutting side and the outer cutting side of the cutting blades 22, 24 may be beveled.

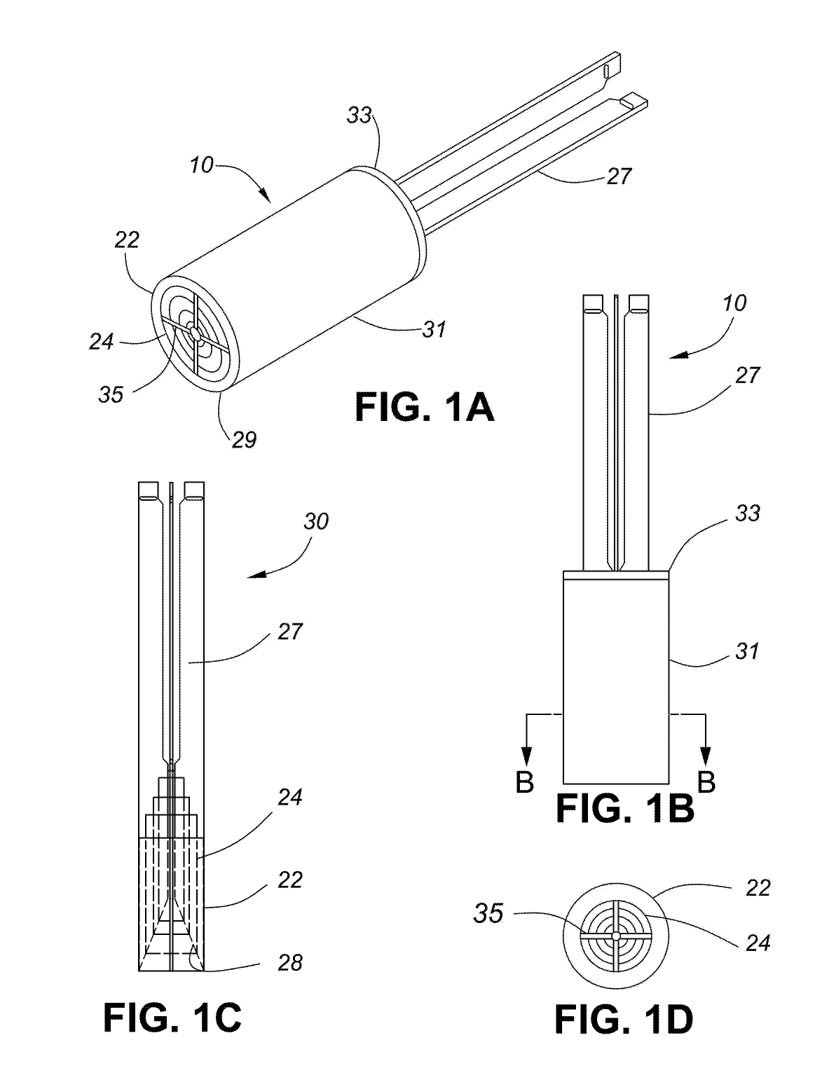

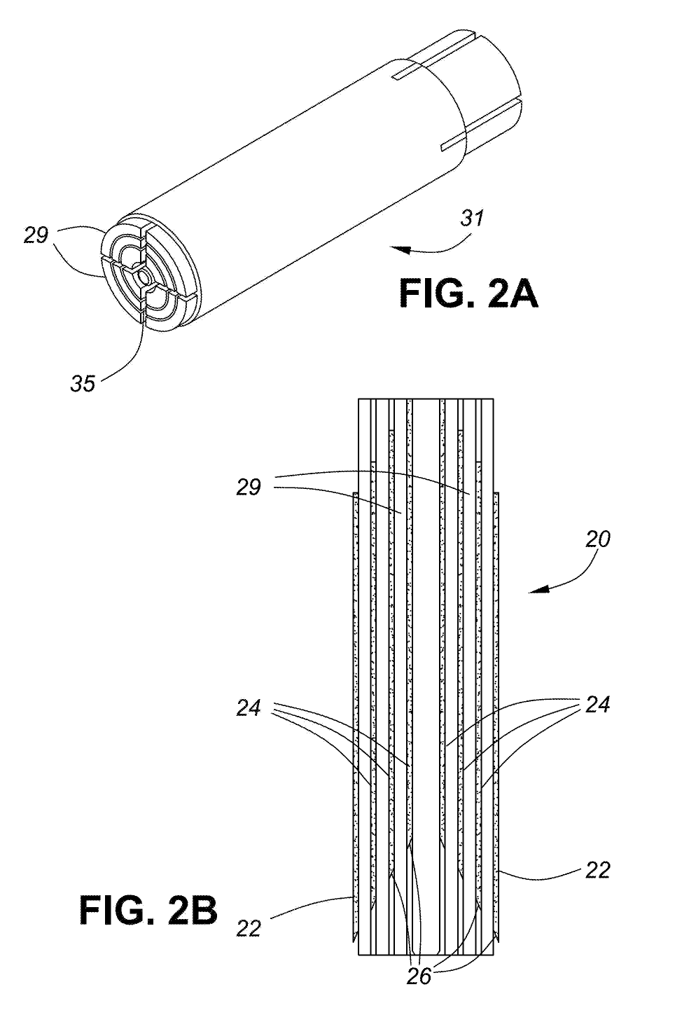

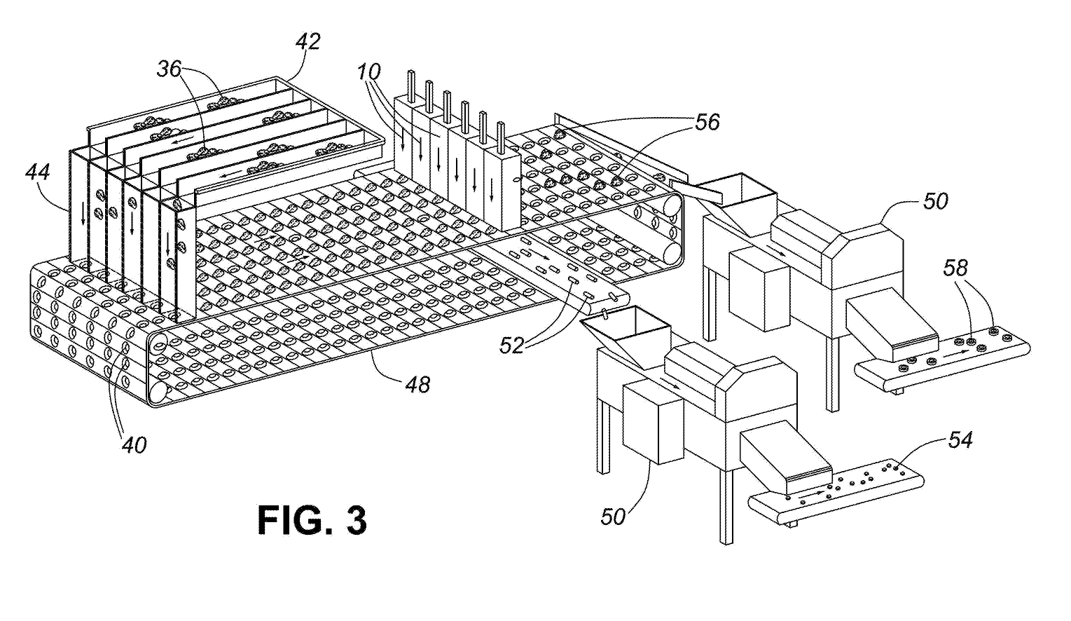

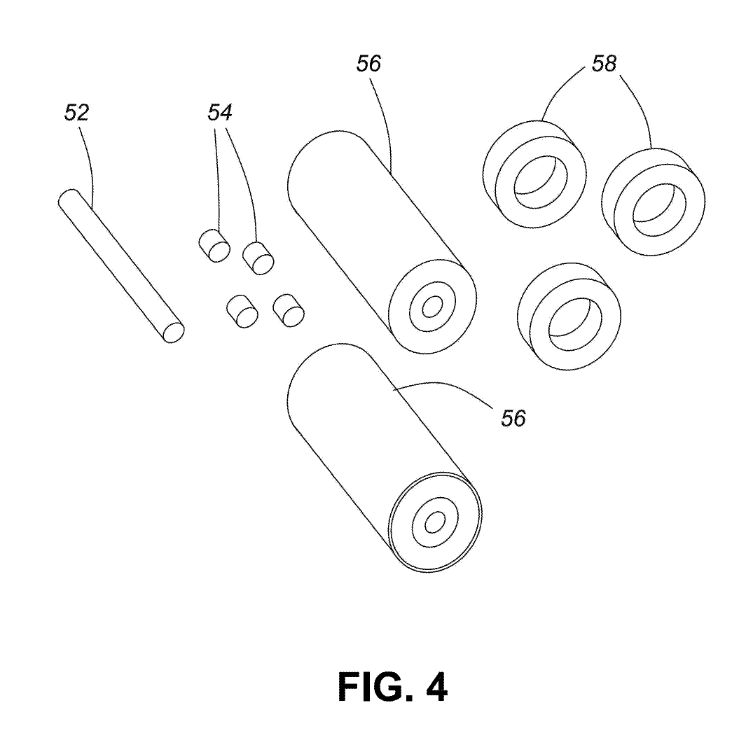

The cutting surfaces 26 of the cutting blades may be staggered as in FIG. 1c, such that, when in the cutting blade assembly 10 is in operation, the cutting surface 26 of the outer cutting blade 22 extends to contact the food material before the cutting surface 26 of the inner cutting blade(s) 24.

Opposite the cutting surfaces 26, one or more connectors 27 may be used to connect the cutting blades to form a unitary piece. At an end opposite the cutting blades, the connectors could connect the cutting assembly to an automated press or the like.

The cutting blades 22, 24 are positioned to have a space between adjacent blades. This space between adjacent cutting blades forms a cutting tube 28 which temporarily contains the cut food when the cutting blade assembly is in operation. Supports 29, which may be provided in by a support means 31, are slidably positioned between adjacent cutting blades 22, 24 in the cutting tubes 28. The supports serve a dual purpose. First the supports maintain the distance between adjacent cutting blades 22, 24 and minimize flexing of the cutting blades 22, 24. Flexing of the cutting blades could cause the blades to break. Second, the supports to assist in removing the cut food material from the cutting tubes 28. The supports may be blade guides or plungers.

Where the supports are blade guides, the blade guides are positioned substantially stationary in the cutting tubes above the cutting area. The cutting blades move towards the cutting area to cut the food article. After cutting the food article, the cutting blades retract, pulling the cutting blades which contain the cut food article in the cutting tubes upwards or otherwise away from the cutting area. The cut food article in the upward moving blades contacts the substantially stationary blade guides. The blade guide halts the upward movement of the cut food article and the cutting blades 22, 24 are retracted from the food article. In so doing, the segments of the cut food are extracted from the cutting tubes 28 together without significant separation of the segments.

Where plungers are used, the plungers are configured to extend beyond the cutting surface of the cutting blades prior to contact of the cutting blades with the food article to be cut. As the cutting blades push through the food article being cut, the plungers retract into the cutting tubes, keeping proper separation of the cutting blades 22, 24, and preventing flexing of the cutting blades 22, 24. Once the cutting means 30 has cut completely through the food article, the plungers are extended, pushing the segments of the cut food article out of the cutting tubes 28.

In either the case of blade guides 27 or plungers 29, the food article which has been cut remains assembled together.

The supports 29 may be attached at a base 33 of the support means 31, opposite the cutting surface of the cutting blades. The supports 29 and the support means 31 may be configured to slidably engage the cutting blades 22, 24 as well as the connectors. The shape of the supports should correspond to the shape of the cutting tubes, allowing some space for the cutting blades to pass through. Further, the support and support means should provide for passage of the connectors 27. As such, for example in FIG. 1a, an X-shaped connector space 35 is provided through the length of the supports. The support means 31 may be inserted onto the cutting means 30 from the connector 27 end of the cutting means.

The elasticity and compressibility of the flesh of the food article assists to prevent the cut food from separating into cylindrical tubes at the time of blade 22, 24 withdrawal or subsequent transport operations to secondary cutter systems. The compression of the flesh of the food material being cut by the cutting blades 22, 24 is necessary to prevent shattering of the flesh during the cutting process, and to ensure that the concentric tubes remain together.

The outer cutting blade 22 may be staggered relative to the at least one inner cutting blade 24 such that, when the blade assembly is in operation, the outer cutting blade 22 extends to contact the food material before the at least one inner cutting blade 24. The outer cutting blade 22 so extended further aids to prevent shattering of the food article by providing a perimeter to contain the food article when the inner cutting blades cut the food article.

The cutting blade assembly 10 described above can be used in a method for cutting a food article into concentric, closed loop shapes.

The process of making French fries involves cleaning the potatoes coming in from the field or supplier to remove dirt, rocks, and other extraneous materials, sizing the potatoes based on their intended use, and then presenting these cleaned tubers to the plant for processing.

Vegetables are extremely crisp at the time of harvest and very prone to shattering upon subjecting them to a cutting operation. The ease of cutting improves later in the year as the vegetables lose their moisture. Reduction of the resistance to cutting and of the shattering that occurs when forcing a plurality of cutter blades through vegetable tissue may be mitigated by changing the form of the starch within the cells. The starch in a vegetable cell exists as a granule composed of amylose and amylopectin suspended in the intercellular fluid within the cell wall.

Starch has a gelatinization temperature of about 120 degrees F. Upon heating the vegetable tissue the starch will begin to gelatinize once the temperature reaches 110F. At this point the resistance to cutting decreases, and the elasticity of the flesh increases, allowing the food article to withstand greater compressive forces. The optimum temperature range for ensuring the proper degree of gelatinization of the starch is 120-130F. Such heating may be accomplished through hot water or microwave heating. At temperatures elevated from this the tissue starts undergoing irreversible changes which result in the loss of elasticity. Cutting of the tissue is still possible, but the tissue will not expand upon removal of the cutter blades and the concentric tubes will have a tendency to separate. This separation renders them unuseable for subsequent transverse cutting to produce closed loop figures of reduced height.

Food material ready to be cut is individually positioned under the cutting blade assembly 20 described above. Optionally, a centre core of the food material to be cut may be removed prior to cutting with the cutting blade assembly 10. The centre core may be removed by a rotating bit which removes a ribbon of material from a centre core of the food material.

For consistent cutting results, the food article 36 can be oriented and positioned properly under the cutting blades to individually place the food article 36 into a positioning means such as an aperture. In a preferred embodiment, the positioning aperture may be pre-formed cups 40. An automatic feed system can be used to feed the food pieces to be cut into the preformed cups that are part of a transport belt 48. In such a system, a chute style feeding mechanism with an alignment shaker 42 feeding to an alignment chute 44 ensures that only a single food piece will be presented to any one cup. As the transport belt 48 advances below the chute 44, the piece to be cut 36 slides on the belt 48 until an empty positioning cup 40 passes below it. The food piece will drop into the cup, which is typically configured to ensure that the cutter means 30 will penetrate the food piece 36 lengthwise, making the longest possible cuts through the food piece.

Another embodiment (not shown) allows the food article to lie flat on the belt should large oval closed loop figures be desired. As the transport belt passes under the cutter assembly, the cutter assembly is forced downwards and through the food piece to be cut. In this arrangement, the configuration of the blades is such that the blades contact the sides of the food piece to be cut first. This acts to further position the food piece, and to prevent the successive penetrations of the inner blades from creating stress fractures in the food piece which would compromise the integrity of the food cylinders being cut by the blades.

When the food articles advance under the cutting assemblies 10, the cutting blades 22, 24 are forced through the food articles 36. Where the centre core 52 of the food article 36 is removed, the centre core 52 may be extracted from the remaining food material and optionally processed through, for instance, an Urschell™ OV slicer 50 into smaller core pieces 54.

The blade assemblies 10 are constructed such that the diameter of the cutter assembly 10 exceeds that of the food article 36 to be cut. In this manner, any size food piece, even irregular shaped pieces, may be cut with a single cutter assembly configuration. Stress on the cutter blades 22, 24 is relieved and proper positioning between concentric rings is ensured by the supports 29 (blade guides or the plungers). These mechanisms ensure that the cutting blades 22, 24 slice through the food piece without deformation of shape or deflection of angle.

The supports 29 also aid in keeping the cut pieces together as cut cylinders 56 for subsequent treatment steps. For instance, typically, the cut cylinders would be transported to secondary cutting by, for example an Urschell™ OV slicer 50, or similar equipment. If the cylinders were separated prior to this secondary cutting, contact with the rotating slicer blades would cause the tubes 56 to collapse and shatter. By keeping the original conformation, the whole food piece can be cut in a transverse fashion, the inner portions of the food piece providing support to the outer layers as they are being cut.

Secondary cutting cuts the cylinders 56 into thin cut shapes 58 having a close configuration. The cut pieces 58 may then be transported over sliver removal and defect sorting systems. The cut pieces 58 may also undergo further treatment. For instance, the cut pieces 58 may be blanched in hot water to inactivate enzymes or cooked to acquire a certain texture. The sugars may also be leached from the outer surfaces. The cut pieces may further be dipped into a preservative solution, dried, fried and frozen. Depending upon the product desired, the cut pieces may also be battered, dusted, flavored or colored. All these processes involve movement of the cut strips and, in the case of the closed loop figures being discussed will act to separate the units one from another. For many of the processes discussed, it is very important that the cut pieces 58 are separated from one another. If they should interlock or tangle with themselves or the equipment they will break or form large masses which interfere with the processing.

Of special consideration is the process of battering of the pieces, where each piece must be separated from every other piece as much as possible to prevent the batter from forming a permanent attachment between pieces and large clumps of product which cannot subsequently be packed or properly dispensed or cooked by the restaurant.

Those skilled in the art will recognize that the present invention can be manifested in a variety of forms other than the specific embodiments described and contemplated herein. Accordingly, departures in form and detail can be made without departing from the scope of the present invention as described in the appended claims.

1. A cutting blade assembly for use in cutting food material into continuous closed-loop shapes, the cutting blade assembly comprising:
a cutting means having an outer cutting blade and at least one inner cutting blade, where the cutting blades are concentrically arranged and the space between adjacent cutting blades forms a cutting tube; and
supports slidably positioned in the cutting tubes to maintain the distance between adjacent cutting blades and to assist in separating cut food material from the cutting blades,
wherein each cutting blade has a closed-loop cross-sectional shape and further wherein each cutting blade has a cutting surface having an inner cutting side and an outer cutting side.

2. The cutting blade assembly of claim 1 where the food material is selected from the group of potato and sweet potato and other similarly shaped vegetables.

3. The cutting blade assembly of claim 1 where the cutting means further comprises at least one connector opposite the cutting surface to connect the outer cutting blade and the at least one inner cutting blade.

4. The cutting blade assembly of claim 1 where the cross sectional shape of each of the cutting blades is independently selected from the group of circle, star, triangle and square.

5. The cutting blade assembly of claim 1 where the inner cutting side of the cutting blades is beveled and the outer cutting side of the cutting blades is flat.

6. The cutting blade assembly of claim 1 where both the inner cutting side and the outer cutting side of the cutting blades are beveled.

7. The cutting blade assembly of claim 1 where the cutting blades are staggered such that the outer cutting blade extends to contact the food material before the at least one inner cutting blade.

8. The cutting blade assembly of claim 1 where the supports are blade guides and where the cutting blades draw the cut food material toward the blade guide, and the blade guide stops the movement of the cut food material, allowing the blades to retract from the cut food material without disturbing the conformation of the cut food material.

9. The cutting blade assembly of claim 1 where the supports are plungers which slide between the cutting blades to force the cut material through the cutter tubes, keeping the cut pieces together.

10. A method for cutting a food material into concentric, closed loop shapes, the method comprising the steps of:
a. individually positioning the food material under the cutting blade assembly of claim 1;
b. forcing the cutting blades through the food material to produce concentric cuts through the food material;
c. removing the cutting blades from the food material such that the concentrically cut food material remains together;
d. further cutting the concentrically cut food material transverse the concentric cuts; and
e. separating the cut food material into concentric shaped food pieces.

11. The method of claim 10, further comprising the pre-steps of:
f. sorting the food material by size;
g. heating the food material to soften the food material;
h. orienting the sized and softened food material into a desired cutting orientation.

12. The method of claim 11 where the heating is done by hot water soaking or microwave energy and where the heating brings the core temperature of the food material to 110-130F.

13. (canceled)

14. The method of claim 11 where the food material is oriented on a conveyor belt comprising means for orienting the food material.

15. The method of claim 14 where the means for orienting the food material are cups.

16. The method of claim 10 where the food material is selected from the group of potato and sweet potato and other similarly shaped vegetables.

17. The method of claim 10 further comprising removing a centre core of the food material to be cut by a rotating bit which removes a ribbon of material from a centre core of the food material during the process of cutting.

18. The method of claim 10 where the concentric shaped food pieces may be further processed by one or more of blanching, drying, coating with a colorant, a flavor, salt, batter, starch, or other coating, frying, oven baking, and freezing.

19. The method according to claim 10 where the removal of the blades from the cut food material is accomplished through use of plungers which force the cut material down through the cutter tubes, leaving the cut piece whole.

20. The method according to claim 10 where the removal of the blades from the cut food material is accomplished by drawing the cutting blades upwards through a blade guide which allows the blades to retract from the food material without disturbing the conformation of the food material.

21. (canceled)

22. The method according to claim 10 where the concentric shaped food pieces are further cut in a direction that is transverse to the concentric cuts, yielding concentric continuous shapes.

23. (canceled)
